(19) United States
(12) Patent Application Publication
(10) Pub. No.: US 2026/0289604 A1
(43) Pub. Date: Sep. 24, 2026

(54) SHORT DRAMA ADVERTISEMENT PROCESSING METHOD AND APPARATUS, DEVICE, AND STORAGE MEDIUM

(71) Applicant: Beijing Youzhuju Network Technology Co., Ltd., Beijing (CN)

(72) Inventors: Xinyu SUN, Beijing (CN); Bo GUO, Beijing (CN); Linyang LI, Beijing (CN); Junquan ZENG, Beijing (CN)

(21) Appl. No.: 19/574,132

(22) Filed: Mar. 20, 2026

(30) Foreign Application Priority Data
Mar. 24, 2025 (CN) 202510353646.6

(51) Int. Cl. G06Q 30/0241

(52) U.S. Cl. CPC G06Q 30/0241

(57) ABSTRACT

Provided are a short drama advertisement processing method and apparatus, a device, and a storage medium. The method includes: sending an advertisement acquisition request to an advertisement platform; receiving a short drama aggregated advertisement sent by the advertisement platform in response to the advertisement acquisition request, where the short drama aggregated advertisement is obtained by aggregating a plurality of short drama advertisements, and the plurality of short drama advertisements include at least a first short drama advertisement and a second short drama advertisement; and displaying the short drama aggregated advertisement on a page, where the page includes a first area and a second area, the first area is used for playing the first short drama advertisement, and the second area is used for displaying information about the second short drama advertisement.

### CROSS-REFERENCE TO RELATED APPLICATIONS

The present application is based on and claims priority to Chinese Patent Application No. 202510353646.6, and filed on March 24, 2025, the entire disclosure of the Chinese Patent Application is hereby incorporated by reference in its entirety.

### TECHNICAL FIELD

The present disclosure relates to the field of computer technologies, and in particular, to a processing method and apparatus for short drama advertisement, a device, and a storage medium.

### BACKGROUND

With the development of computer technologies and network technologies, some short drama platforms have emerged, and users may watch short dramas on the short drama platforms. A short drama is a form of drama with a relatively short length. Compared with a large-scale drama and a television drama, the short drama has a relatively short duration.

In order to improve a playback rate of a short drama, a short drama advertisement may be delivered on a media platform. For example, some exciting plot segments of the short drama can be used as the short drama advertisement to attract users to continue watching the entire short drama after watching the short drama advertisement.

### SUMMARY

In order to solve or at least partially solve the above technical problem, the present disclosure provides a short drama advertisement processing method and apparatus, a device, and a storage medium.

In a first aspect, the present disclosure provides a short drama advertisement processing method, including:

sending an advertisement acquisition request to an advertisement platform;

receiving a short drama aggregated advertisement sent by the advertisement platform in response to the advertisement acquisition request, wherein the short drama aggregated advertisement is obtained by aggregating a plurality of short drama advertisements, and the plurality of short drama advertisements comprise at least a first short drama advertisement and a second short drama advertisement; and

displaying the short drama aggregated advertisement on a page, wherein the page comprises a first area and a second area, wherein the first area is used for playing the first short drama advertisement, and the second area is used for displaying information about the second short drama advertisement.

In a second aspect, the present disclosure provides a short drama advertisement processing apparatus, including:

a sending unit, configured to send an advertisement acquisition request to an advertisement platform;

a receiving unit, configured to receive a short drama aggregated advertisement sent by the advertisement platform in response to the advertisement acquisition request, wherein the short drama aggregated advertisement is obtained by aggregating a plurality of short drama advertisements, and the plurality of short drama advertisements comprise at least a first short drama advertisement and a second short drama advertisement; and

a displaying unit, configured to display the short drama aggregated advertisement on a page, wherein the page comprises a first area and a second area, wherein the first area is used for playing the first short drama advertisement, and wherein the second area is used for displaying information about the second short drama advertisement.

In a third aspect, the present disclosure provides an electronic device, including: a processor and a memory;

where the memory is configured to store an instruction or a computer program; and

where the processor is configured to execute the instruction or the computer program in the memory to cause the electronic device to perform the method as discussed in the above first aspect.

In a fourth aspect, the present disclosure provides a computer-readable medium having an instruction or a computer program stored thereon, where the instruction or the computer program, when executed by a device, causes the device to perform the method as discussed in the above first aspect.

In a fifth aspect, the present disclosure provides a computer program product, including a computer program carried on a non-transitory computer-readable medium, where the computer program includes program codes for performing the method as discussed in the above first aspect.

### BRIEF DESCRIPTION OF THE DRAWINGS

In order to more clearly illustrate the technical solutions in the embodiments of the present disclosure or in the related art, the following briefly introduces drawings required for describing the embodiments or the related art. Apparently, the drawings in the following description show merely some embodiments of the present disclosure, and a person of ordinary skill in the art may still derive other drawings from these drawings without paying creative efforts.

FIG. 1 is a schematic diagram of an advertisement delivery manner;

FIG. 2 is a schematic flowchart of a short drama advertisement processing method according to an embodiment of the present disclosure;

FIG. 3 is a schematic diagram of roles involved in delivery of a short drama aggregated advertisement;

FIG. 4 is a schematic flowchart of a communication method according to an embodiment of the present disclosure;

FIG. 5 is a structural diagram of a page according to an embodiment of the present disclosure;

FIG. 6 is a structural diagram of a short drama advertisement processing apparatus according to an embodiment of the present disclosure; and

FIG. 7 is a structural diagram of an electronic device according to an embodiment of the present disclosure.

### DETAILED DESCRIPTION

In order for persons skilled in the art to better understand the solutions of the present disclosure, the technical solutions in the embodiments of the present disclosure are described below clearly and completely with reference to the drawings in the embodiments of the present disclosure. Apparently, the described embodiments are merely some rather than all of the embodiments of the present disclosure. All other embodiments derived by a person of ordinary skill in the art based on the embodiments of the present disclosure without paying creative efforts shall fall within the scope of protection of the present disclosure.

At present, an advertiser may deliver a short drama advertisement on a media platform through an advertisement platform. The advertisement platform used by the advertiser for providing advertisements is a system that connects the advertiser with the media platform that provides advertisement exposure opportunities. The role of the advertisement platform is similar to an advertisement agency, which provides a bridge for the media platform to provide advertisement exposure opportunities to the advertiser.

Reference may be made to FIG. 1, and FIG. 1 is a schematic diagram of an advertisement delivery manner.

As shown in FIG. 1, the advertiser provides short drama advertisement materials to the advertisement platform, and the advertisement platform may be connected to several media platforms. For convenience of understanding, FIG. 1 shows only one media platform. The media platform may send an advertisement acquisition request to the advertisement platform, and upon receiving the advertisement acquisition request, the advertisement platform determines, according to a certain policy, an advertisement which is to be returned to the media platform, and further returns the advertisement to the media platform for playing the advertisement on the media platform.

The advertisement platform has its own software development kit (SDK). If the advertisement platform determines to return the short drama advertisement to the media platform, the advertisement platform uses its SDK to render materials of the short drama advertisement, and sends a rendering result to the media platform, so that the media platform plays the short drama advertisement based on the rendering result.

However, the current manner of short drama advertisement delivery cannot achieve a good short drama delivery effect. Specifically, after being delivered, the short drama advertisement cannot attract more users to watch a short drama corresponding to the short drama advertisement.

The inventor of the present disclosure has found that the reason for the poor delivery effect of the current short drama advertisement may be that: the current short drama advertisements are all for a single short drama, and if there are a large number of users who are not interested in the single short drama, the short drama advertisement cannot achieve a good delivery effect. If short drama advertisements corresponding to a plurality of short dramas may be aggregated to enable a user to obtain information about more short dramas through one advertisement, the delivery effect of the short drama advertisements may be effectively improved. In view of this, embodiments of the present disclosure provide a short drama advertisement processing method and apparatus, a device, a storage medium, and a computer program product.

Next, the solutions provided in embodiments of the present disclosure will be introduced.

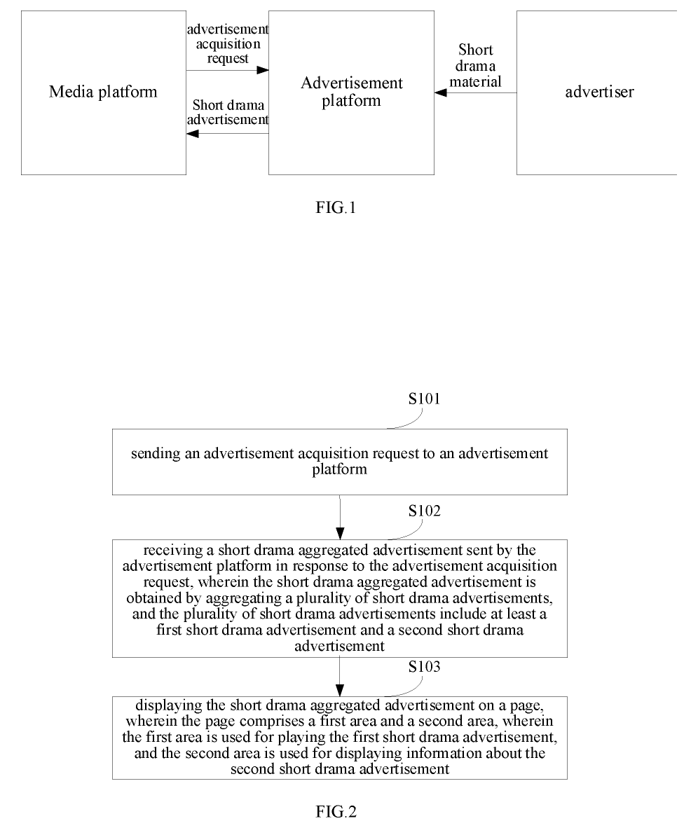

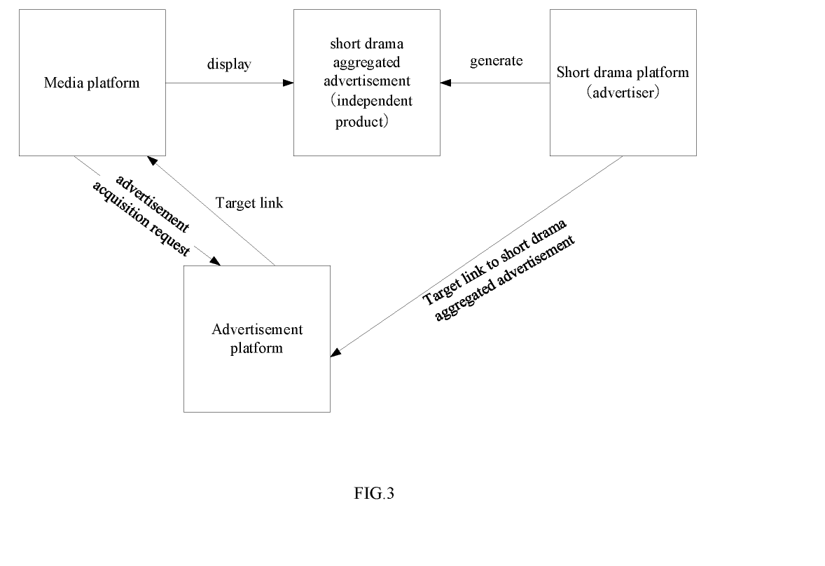

Reference is made to FIG. 2, which is a schematic flowchart of a short drama advertisement processing method according to an embodiment of the present disclosure.

The method shown in FIG. 2 is appliable to, for example, a client, and the client is, for example, a client corresponding to a media platform. The method shown in FIG. 2 includes the following steps S101 to S103.

S101: sending an advertisement acquisition request to an advertisement platform.

In an example, the client may send the advertisement acquisition request to the advertisement platform in response to a page switching operation triggered by a user. For example, after the user triggers the page switching operation, the client determines that a next page may be used for displaying an advertisement, therefore, the client sends the advertisement acquisition request to the advertisement platform in response to the page switching operation.

For the concept of the advertisement platform, reference may be made to the relevant description above, and details are not repeated here. The advertisement platform mentioned here may be any existing advertisement platform or any advertisement platform that may appear in the future. The format of the advertisement acquisition request may follow the format of a traditional advertisement acquisition request, which are not described in detail here.

S102: receiving a short drama aggregated advertisement sent by the advertisement platform in response to the advertisement acquisition request, wherein the short drama aggregated advertisement is obtained by aggregating a plurality of short drama advertisements, and the plurality of short drama advertisements include at least a first short drama advertisement and a second short drama advertisement.

After the client sends the advertisement acquisition request to the advertisement platform, the advertisement platform makes a response upon receiving the advertisement acquisition request. Specifically, the advertisement platform may select an appropriate advertisement from advertisements that may be delivered by the advertisement platform, and return the appropriate advertisement to the client, so that the client displays the received advertisement. For example, the advertisement platform may select an appropriate advertisement and return the appropriate advertisement to the client according to a certain policy.

In an example, the advertisement platform determines to return a short drama aggregated advertisement to the client. The short drama aggregated advertisement is obtained by aggregating a plurality of short drama advertisements, and each of the plurality of short drama advertisements corresponds to one short drama. In other words, the short drama aggregated advertisement is not an advertisement for a single short drama, but an advertisement for a plurality of short dramas.

In a specific example, the advertisement platform may obtain a plurality of short drama advertisements provided by an advertiser, and further aggregate the plurality of short drama advertisements to obtain the short drama aggregated advertisement. Further, the short drama aggregated advertisement is sent to the client. For example, the advertisement platform uses its SDK to render the short drama aggregated advertisement, and sends a rendering result to the client. To aggregate a plurality of short drama advertisements may be, for example, to splice the plurality of short drama advertisements into a new short drama advertisement including the plurality of short drama advertisements, and the new short drama advertisement is the short drama aggregated advertisement. The advertiser may be, for example, a short drama platform.

In another specific example, the short drama aggregated advertisement is obtained by the advertiser aggregating a plurality of short drama advertisements. In this scenario, the advertiser may not need to provide the short drama aggregated advertisement to the advertisement platform, and may not need to provide the plurality of short drama advertisements to the advertisement platform. The advertiser, for example, may provide the advertisement platform with a target link through which the short drama aggregated advertisement may be obtained. In this scenario, in a specific implementation of S102, the client may receive the target link sent by the advertisement platform. In this scenario, the short drama aggregated advertisement does not depend on the advertisement platform to perform the aggregation operation, and does not depend on the SDK of the advertisement platform to render the short drama aggregated advertisement. The short drama aggregated advertisement itself is an independent product. Therefore, in this scenario, the short drama aggregated advertisement may be compatible to any advertisement platform, so that the short drama aggregated advertisement has an opportunity to be delivered on each media platform. In an example, the short drama aggregated advertisement itself is an independent product supporting automatic loading by using the fifth-generation HyperText Markup Language (H5).

S103: displaying the short drama aggregated advertisement on a page, wherein the page comprises a first area and a second area, wherein the first area is used for playing the first short drama advertisement, and the second area is used for displaying information about the second short drama advertisement.

Upon receiving the short drama aggregated advertisement sent by the advertisement platform, the client displays the short drama aggregated advertisement on the page. In order to improve an efficiency of the user obtaining information through the page, thereby improving the delivery effect of the short drama aggregated advertisement, in the present disclosure, the page includes the first area and the second area, the first area is used for playing the first short drama advertisement, and the second area is used for displaying the information about the second short drama advertisement.

For convenience of description, a short drama corresponding to the first short drama advertisement is referred to as a first short drama, and a short drama corresponding to the second short drama advertisement is referred to as a second short drama.

As described in the background section, some exciting plots of a short drama may be used as a short drama advertisement. Therefore, playing the first short drama advertisement may refer to playing exciting plots in the first short drama to attract the user to watch the complete short drama.

In an example, the client supports automatic loading of a short drama advertisement landing page by using H5. When the page is displayed, the first short drama advertisement is automatically played in the first area.

In another example, the client does not support automatic loading of the short drama advertisement landing page by using H5. When the page is displayed, a static image corresponding to the first short drama advertisement is first displayed in the first area, and after the user triggers a playing operation (for example, a click operation) on the first area, the first short drama advertisement is played in the first area.

In an example, the advertisement acquisition request may include indication information indicating whether the client supports automatic loading of an advertisement landing page by using H5, so that the advertisement platform can select an appropriate advertisement and return the appropriate advertisement to the client based on the indication information and a policy of the advertisement platform itself.

The second area is used for displaying information about the second short drama advertisement, and the information about the second short drama advertisement may be, for example, introduction information of the second short drama. For example, the information about the second short drama advertisement may be a cover picture of the second short drama, and the cover picture includes, for example, a name of the second short drama, an image of a character in the second short drama, and other information related to the second short drama, which will not be listed here one by one.

In embodiments of the present disclosure, a relative position between the first area and the second area on the page is not specifically limited. For example, the page can be divided into an upper area and a lower area, the first area is located in the upper area of the page, and the second area is located in the lower area of the page. For another example, the page can be divided into a left area and a right area, the first area is located in the left area of the page, and the second area is located in the right area of the page.

In an example, the plurality of short drama advertisements further include other short drama advertisements in addition to the first short drama advertisement and the second short drama advertisement, for example, further include a third short drama advertisement and even a fourth short drama advertisement. In this scenario, the second area includes a plurality of sub-areas, and each of the sub-areas displays information about one short drama advertisement. In an example, the information about the second short drama advertisement is displayed in one of the plurality of sub-areas. In this scenario, the user may obtain information about a plurality of short drama advertisements through the second area, which effectively improves the efficiency of obtaining information. Correspondingly, compared with one short drama advertisement, the information about the plurality of short drama advertisements in the second area can be more attractive to the user, so that the delivery effect of the short drama aggregated advertisements may be improved.

In an example, a first control is further displayed in the first area, and the first control is used for triggering to view a short drama corresponding to the first short drama advertisement. In this scenario, if the user wants to watch the complete first short drama after watching the first short drama advertisement played in the first area, the user may trigger a corresponding operation for the first control. For example, the user may click on the first control. Correspondingly, the client may redirect to a short drama platform corresponding to the first short drama advertisement in response to the operation triggered for the first control, so that the user continues to watch the first short drama. In this case, if the user is interested in the first short drama, the user does not need to first exit the current media platform and then manually search for a short drama platform that plays the first short drama, to further go to the short drama platform to watch the first short drama. Based on the first control, it can redirect to the short drama platform corresponding to the first short drama advertisement directly from the current page, which simplifies the user’s operation and further improves the delivery effect of the short drama aggregated advertisements.

In an example, for the information about the second short drama advertisement displayed in the second area, if the user has a certain interest in the second short drama after viewing the information and wants to learn more content related to the second short drama, the user may trigger a short drama advertisement viewing operation for the information about the second short drama advertisement in the second area. As an example, the user may click on an area where the information about the second short drama advertisement is located to trigger the short drama advertisement viewing operation. For convenience of description, a sub-area in the second area that is used for displaying the information about the second short drama advertisement is referred to as a first sub-area. The user may trigger the short drama advertisement viewing operation (for example, a click operation) for the first sub-area. Correspondingly, the client may switch the content played in the first area to the second short drama advertisement in response to the short drama advertisement viewing operation. In other words, after the user triggers the short drama advertisement viewing operation, the first short drama advertisement is no longer played in the first area, but the second short drama advertisement is played, to satisfy the requirement of the user for viewing the second short drama advertisement.

After the short drama advertisement played in the first area is switched from the first short drama advertisement to the second short drama advertisement, an interaction operation supported by the second short drama advertisement is similar to an interaction operation supported by the first short drama advertisement (that is, the first area playing the first short drama advertisement) mentioned above, and their details are not repeated here.

In an example, a second control is further displayed in the second area, and the second control is used for triggering to view a short drama corresponding to the second short drama advertisement. Specifically, the second control is displayed in the first sub-area. In this scenario, if the user wants to watch the complete second short drama after viewing the information about the second short drama advertisement displayed in the second area, the user may trigger a corresponding operation for the second control. For example, the user may click on the second control. Correspondingly, the client may redirect to a short drama platform corresponding to the second short drama advertisement in response to the operation triggered for the second control, to continue to watch the second short drama. In this case, if the user has an interest in the second short drama only by viewing the information about the second short drama advertisement, the user does not need to first exit the current media platform and then manually search for a short drama platform that plays the short drama, to further go to the short drama platform to watch the second short drama. Based on the second control, it can redirect to the short drama platform corresponding to the second short drama advertisement directly from the current page, which simplifies the user’s operation and further improves the delivery effect of the short drama aggregated advertisement.

As may be seen from the above description, with the solution provided in the embodiments of the present disclosure, when displaying a short drama aggregated advertisement, the client can display the first short drama advertisement in the first area and display the second short drama advertisement in the second area. Specifically, the first area is used for playing the first short drama advertisement, and the second area is used for displaying the information about the second short drama advertisement. In this way, a user may query a plurality of short drama advertisements on the page. Moreover, the first short drama advertisement is played in the first area, so that the user may have a deeper understanding of a short drama corresponding to the first short drama advertisement. Delivery of short drama advertisements in this manner may attract more users to watch short dramas on a short drama platform, thereby improving the delivery effect of the short drama advertisements.

The solutions provided in the embodiments of the present disclosure are introduced above. Next, a possible implementation scenario of the present disclosure is described with reference to the drawings.

FIG. 3 is a schematic diagram of roles involved in the delivery of short drama aggregated advertisements. As shown in FIG. 3:

The roles involved in the short drama aggregated advertisement include: a media platform, an advertisement platform, a short drama platform, and a short drama aggregated advertisement. The short drama aggregated advertisement is an independent product. As described above, the short drama aggregated advertisement may be obtained by an advertiser aggregating a plurality of short drama advertisements, and the short drama platform also acts as the advertiser.

As shown in FIG. 3, the advertiser applies to the advertisement platform for advertisement delivery, and the advertiser provides the advertisement platform with a target link of the short drama aggregated advertisement. The media platform requests an advertisement from the advertisement platform, and the advertisement platform returns the target link of the short drama aggregated advertisement to the media platform according to a certain policy. Correspondingly, the media platform obtains the short drama aggregated advertisement based on the target link, and displays the short drama aggregated advertisement. Through a triggering operation on the displayed short drama aggregated advertisement, the user may redirect to the short drama platform.

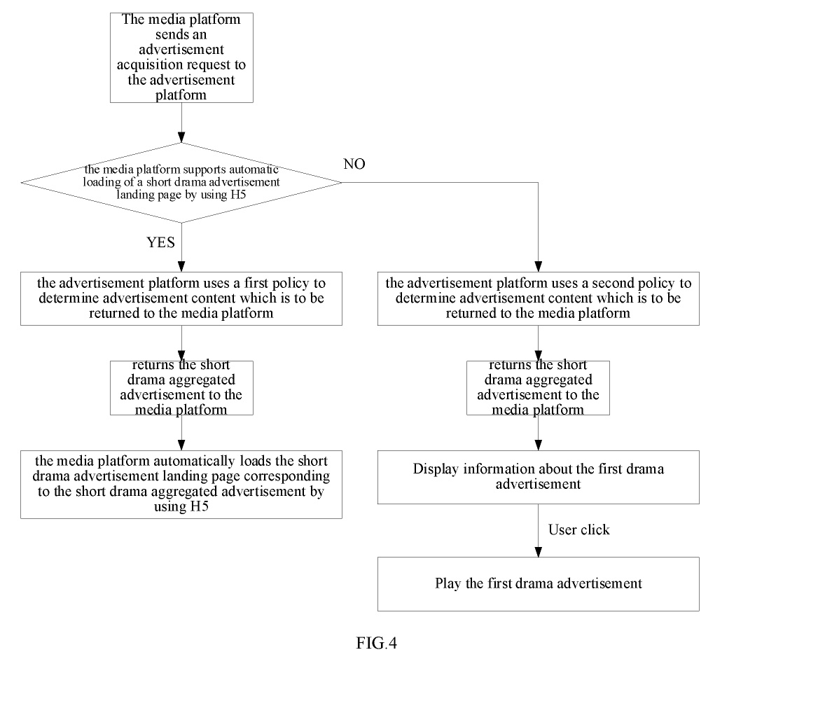

Regarding the interaction between the media platform and the advertisement platform, reference may be made to FIG. 4, which is a schematic flowchart of a communication method according to an embodiment of the present disclosure.

As shown in FIG. 4:

The media platform sends an advertisement acquisition request to the advertisement platform. Optionally, the request carries indication information indicating whether the media platform supports automatic loading of a short drama advertisement landing page by using H5.

If the media platform supports automatic loading of the short drama advertisement landing page by using H5, the advertisement platform uses a first policy to determine advertisement content which is to be returned to the media platform. If the media platform does not support automatic loading of the short drama advertisement landing page by using H5, the advertisement platform uses a second policy to determine the advertisement content which is to be returned to the media platform.

With respect to the first policy and the second policy, it should be noted that to play an advertisement on the media platform, certain resources need to be provided to the media platform, and the first policy and the second policy are used for determining an amount of resources provided to the media platform. In general, for the same short drama aggregated advertisement, if the media platform supports automatic loading of the short drama advertisement landing page by using H5, more resources need to be provided to the media platform compared to that the media platform does not support automatic loading of the short drama advertisement landing page by using H5.

The advertisement platform returns the short drama aggregated advertisement to the media platform based on the first policy or the second policy.

Upon receiving the short drama aggregated advertisement, the media platform displays the short drama aggregated advertisement. Specifically:

if the media platform supports automatic loading of the short drama advertisement landing page by using H5, the media platform automatically loads the short drama advertisement landing page corresponding to the short drama aggregated advertisement by using H5. When the short drama advertisement landing page is automatically loaded by using the H5 technology, the first short drama advertisement is automatically played.

If the media platform does not support automatic loading of the short drama advertisement landing page by using H5, when loading the first short drama advertisement, the media platform does not automatically play the first short drama advertisement, but displays information about the first short drama advertisement, and after the user clicks on the information about the first short drama advertisement, the first short drama advertisement is played. The information about the first short drama advertisement is similar to the information about the second short drama advertisement, and the information about the first short drama advertisement also includes recommendation information of the first short drama. For the information about the first short drama advertisement, reference may be made to the description of the information about the second short drama advertisement above, and details are not repeated here.

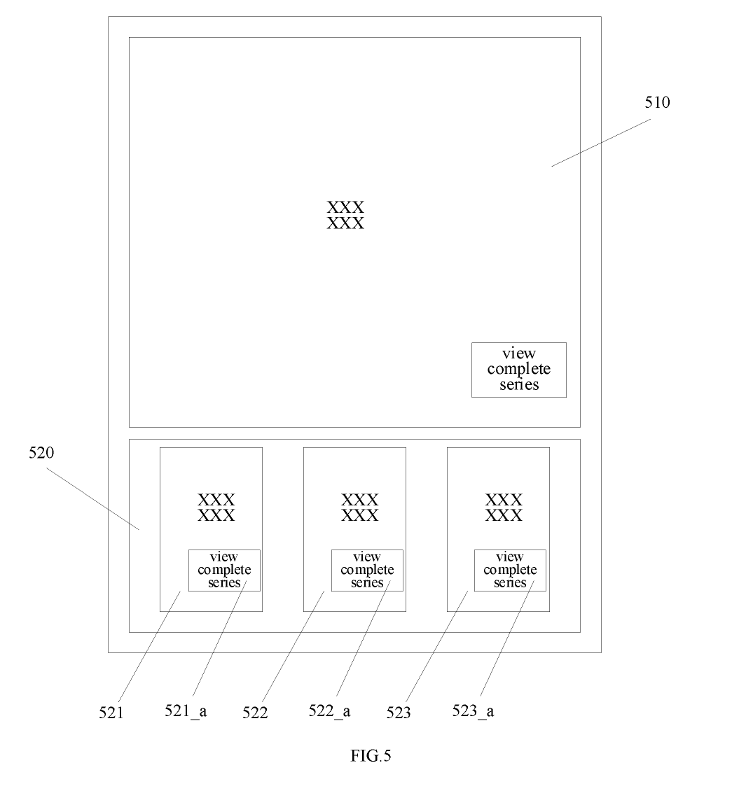

For the page used by the media platform to display the short drama aggregated advertisement, reference may be made to FIG. 5, which is a structural diagram of a page according to an embodiment of the present disclosure.

As shown in FIG. 5, the page includes a first area 510 and a second area 520, the first area 510 is used for playing a first short drama advertisement, and the second area 520 includes a plurality of sub-areas. For convenience of description, three sub-areas are shown in FIG. 5, which are 521, 522, and 523. For example, the sub-area 521 is used for displaying information about a second short drama advertisement, the sub-area 522 is used for displaying information about a third short drama advertisement, and the sub-area 523 is used for displaying information about a fourth short drama advertisement.

The first area 510 includes a first control 511, and the user may trigger an operation through the first control 511 to cause the client to redirect to a short drama platform corresponding to the first short drama.

Each sub-area in the second area 520 includes a corresponding second control. For example, the sub-area 521 includes a second control 521_a, the sub-area 522 includes a second control 522_a, and the sub-area 523 includes a second control 523_a.

Interaction manners supported by respective sub-areas in the second area 520 are similar, taking the sub-area 521 as an example:

the user may click on the sub-area 521 (for example, click on a central area of the sub-area 521) to cause the client to play the second short drama advertisement in the first area 510; and

the user may trigger an operation through the second control 521_a to cause the client to redirect to the short drama platform corresponding to the second short drama.

In FIG. 5, both content of the first short drama advertisement played in the first area 510 and content of the short drama advertisement displayed in the second area 520 are represented by "XXX". In addition, the texts corresponding to the first control and the second control shown in FIG. 5 are only shown for convenience of understanding, but do not constitute a limitation on the embodiments of the present disclosure.

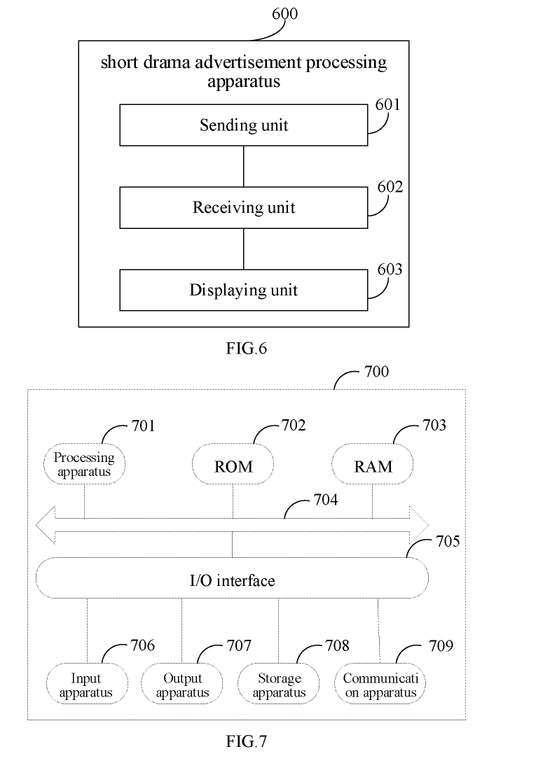

Based on the short drama advertisement processing method provided in the embodiments of the present disclosure, the embodiments of the present disclosure further provide a short drama advertisement processing apparatus, which will be described below with reference to FIG. 6. FIG. 6 is a structural diagram of a short drama advertisement processing apparatus according to an embodiment of the present disclosure. It should be noted that for technical details of the short drama advertisement processing apparatus provided in the embodiments of the present disclosure, reference may be made to the relevant content of the short drama advertisement processing method above.

As shown in FIG. 6, a short drama advertisement processing apparatus 600 provided by an embodiment of the present disclosure includes: a sending unit 601, a receiving unit 602, and a displaying unit 603.

The sending unit 601 is configured to send an advertisement acquisition request to an advertisement platform.

The receiving unit 602 is configured to receive a short drama aggregated advertisement sent by the advertisement platform in response to the advertisement acquisition request, wherein the short drama aggregated advertisement is obtained by aggregating a plurality of short drama advertisements, and the plurality of short drama advertisements comprise at least a first short drama advertisement and a second short drama advertisement.

The display unit 603 is configured to display the short drama aggregated advertisement on a page, wherein the page comprises a first area and a second area, wherein the first area is used for playing the first short drama advertisement, and wherein the second area is used for displaying information about the second short drama advertisement.

Optionally, the receiving unit 602 is configured to:

receive a target link sent by the advertisement platform, wherein the target link is used for obtaining the short drama aggregated advertisement, wherein the target link is provided by an advertiser of the short drama aggregated advertisement to the advertisement platform, and wherein the short drama aggregated advertisement is obtained by the advertiser aggregating the plurality of short drama advertisements.

Optionally, the apparatus further includes:

a first redirecting unit, configured to redirect to a short drama platform corresponding to the first short drama advertisement in response to an operation triggered by a user on a first control in the first area, wherein the first control is used for triggering to view a short drama corresponding to the first short drama advertisement.

Optionally, the apparatus further includes:

a switching unit, configured to switch contents played in the first area to the second short drama advertisement, in response to a short drama advertisement viewing operation triggered by a user for information about the second short drama advertisement in the second area.

Optionally, the apparatus further includes:

a second redirecting unit, configured to redirect to a short drama platform corresponding to the second short drama advertisement in response to an operation triggered by a user on a second control in the second area, wherein the second control is used for triggering to view a short drama corresponding to the second short drama advertisement.

Optionally, the second area includes a plurality of sub-areas, each of the sub-areas displays information about one short drama advertisement, and the second short drama advertisement is one of a plurality of short drama advertisements displayed in the second area.

It may be seen from the above related content of the short drama advertisement processing apparatus 600 that a user may query a plurality of short drama advertisements on the page. Moreover, the first short drama advertisement is played in the first area, so that the user may have a deeper understanding of a short drama corresponding to the first short drama advertisement. Delivery of short drama advertisements in this manner may attract more users to watch short dramas on a short drama platform, thereby improving the delivery effect of the short drama advertisements.

In addition, an embodiment of the present disclosure further provides an electronic device, including a processor and a memory, where the memory is configured to store an instruction or a computer program, and the processor is configured to execute the instruction or the computer program in the memory to cause the electronic device to perform any implementation of the short drama advertisement processing method provided in the embodiments of the present disclosure.

FIG. 7 is a structural diagram of an electronic device 700 suitable for implementing an embodiment of the present disclosure. A terminal device in the embodiments of the present disclosure may include, but is not limited to, a mobile terminal such as a mobile phone, a notebook computer, a digital broadcast receiver, a personal digital assistant (PDA), a tablet computer (PAD), a portable multimedia player (PMP), and an in-vehicle terminal (such as an in-vehicle navigation terminal), and a fixed terminal such as a digital TV and a desktop computer. The electronic device shown in FIG. 7 is merely an example, and shall not impose any limitation on the functions and usage scopes of the embodiments of the present disclosure.

As shown in FIG. 7, the electronic device 700 may include a processing apparatus (such as, a central processing unit and a graphics processor) 701, which may perform various appropriate actions and processing according to a program stored in a read-only memory (ROM) 702 or a program loaded from a storage apparatus 708 into a random-access memory (RAM) 703. The RAM 703 further stores various programs and data required for operations of the electronic device 700. The processing apparatus 701, ROM 702, and RAM 703 are interconnected via a bus 704. An input/output (I/O) interface 705 is also connected to the bus 704.

Usually, the following apparatuses may be connected to the I/O interface 705: an input apparatus 706 including, for example, a touch screen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a magnetic tape and a hard disk; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or provide all the apparatuses shown. Alternatively, more or fewer apparatuses may be implemented or provided.

In particular, according to an embodiment of the present disclosure, the process described above with reference to the flowchart may be implemented as a computer software program. For example, an embodiment of the present disclosure includes a computer program product, including a computer program carried on a non-transitory computer-readable medium, where the computer program includes program codes for performing the method shown in the flowchart. In such an embodiment, the computer program may be downloaded from a network through the communication apparatus 709 and installed, or installed from the storage apparatus 708, or installed from the ROM 702. When the computer program is executed by the processing apparatus 701, the preceding functions defined in the method according to the embodiments of the present disclosure are performed.

The electronic device provided in the embodiment of the present disclosure belongs to the same inventive concept as the method provided in the preceding embodiments. For the technical details not described in detail in this embodiment, reference may be made to the preceding embodiments, and this embodiment has the same beneficial effects as the preceding embodiments.

An embodiment of the present disclosure further provides a computer-readable medium having an instruction or a computer program stored thereon, where the instruction or the computer program, when executed on a device, causes the device to perform any implementation of the short drama advertisement processing method provided in the embodiments of the present disclosure.

It should be noted that the computer-readable medium in the present disclosure may be a computer-readable signal medium, a computer-readable storage medium, or any combination thereof. The computer-readable storage medium may be, for example, but not limited to, an electronic, magnetic, optical, electromagnetic, infrared, or semiconductor system, apparatus, or device, or any combination thereof. More specific examples of the computer-readable storage medium may include, but not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or used in combination with an instruction execution system, apparatus, or device. In the present disclosure, the computer-readable signal medium may include a data signal propagated on a baseband or as a part of a carrier, and computer-readable program codes are carried in the data signal. Such propagated data signal may be in multiple forms, and includes, but not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program codes contained on the computer-readable medium may be transmitted in any suitable medium, including, but not limited to, a wire, an optical cable, a radio frequency (RF), or any suitable combination thereof.

In some implementations, the client and the server may communicate using any currently known or future developed network protocol, such as the Hyper Text Transfer Protocol (HTTP), and may be interconnected with any form or medium of digital data communication (for example, a communication network). Examples of the communication network include a local area network ("LAN"), a wide area network ("WAN"), an internet (for example, the Internet), a peer-to-peer network (for example, an Ad-Hoc network), and any network currently known or to be developed in the future.

The computer-readable medium may be contained in the electronic device mentioned above, or may exist alone without being assembled into the electronic device.

The computer-readable medium carries one or more programs, and the one or more programs, when executed by the electronic device, cause the electronic device to perform the method mentioned above.

The computer program codes for performing operations of the present disclosure may be written in one or more programming languages or a combination thereof, where the programming languages may include, but not limited to, an object-oriented programming language, such as Java, Smalltalk, and C++, and further include conventional procedural programming languages, such as "C" language or similar programming languages. The program codes may be completely executed on a computer of a user, partially executed on a computer of a user, executed as an independent software package, partially executed on a computer of a user and partially executed on a remote computer, or completely executed on a remote computer or server. In the case involving the remote computer, the remote computer may be connected to the computer of the user through any kind of network, including a local area network (LAN) or a wide area network (WAN), or may be connected to an external computer (for example, connected through the Internet using an Internet service provider).

The flowcharts and block diagrams in the drawings illustrate possibly implemented architectures, functions, and operations of the system, the method, and the computer program product according to various embodiments of the present disclosure. In this regard, each block in the flowchart or block diagram may represent a module, program segment, or part of codes, and the module, program segment, or part of codes contains one or more executable instructions for implementing specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart and a combination of the blocks in the block diagram and/or the flowchart may be implemented by a dedicated hardware-based system that executes specified functions or operations, or may be implemented by a combination of dedicated hardware and computer instructions.

The involved units described in embodiments of the present disclosure may be implemented by software or by hardware. The name of the unit/module does not constitute a limitation on the unit itself under certain circumstances.

The functions described above herein may be at least partially performed by one or more hardware logic components. For example, without limitation, exemplary types of the hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program to be used by or in combination with an instruction execution system, apparatus, or device. The machine-readable medium may be a machine-readable signal medium or a machine-readable storage medium. The machine-readable medium includes, but not limited to, an electronic, magnetic, optical, electromagnetic, infrared, or semiconductor system, apparatus, or device, or any suitable combination thereof. More specific examples of the machine-readable storage medium include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

It should be noted that embodiments in the present specification are described in a progressive manner, and each embodiment focuses on the difference from other embodiments. For the same and similar parts between the embodiments, reference may be made to each other. For the system or apparatus disclosed in the embodiments, since it corresponds to the method disclosed in the embodiments, the description is relatively simple, and reference may be made to the description of the method for the relevant parts.

It should be understood that in the present disclosure, "at least one" means one or more, and "a plurality of" means two or more. "And/or" describes an association relationship between associated objects, and represents that three types of relationships may exist. For example, "A and/or B" may represent the following three cases: only A exists, only B exists, and both A and B exist, where A and B may be singular or plural. The character "/" generally indicates an "or" relationship between the associated objects. "At least one of the following items (pieces)" or a similar expression thereof indicates any combination of these items, including a single item (piece) or any combination of a plurality of items (pieces). For example, at least one of a, b, or c may represent: a, b, c, "a and b", "a and c", "b and c", or "a, b, and c", where a, b, and c may be singular or plural.

It should also be noted that in this article, relational terms such as first and second are used only to distinguish one entity or operation from another entity or operation, and do not necessarily require or imply any actual relationship or order between these entities or operations. Moreover, the terms "comprise", "include", or any other variant thereof are intended to cover non-exclusive inclusion, so that a process, method, item, or device that includes a list of elements includes not only those elements, but also other elements not explicitly listed or elements inherent to such a process, method, item, or device. Without further restrictions, an element defined by the phrase "includes a" does not exclude the existence of other identical elements in the process, method, item, or device that includes the element.

The steps of the method or algorithm described in conjunction with the embodiments disclosed herein may be directly implemented in hardware, a software module executed by a processor, or a combination thereof. The software module may be placed in a random-access memory (RAM), a memory, a read-only memory (ROM), an electrically programmable ROM, an electrically erasable programmable ROM, a register, a hard disk, a removable magnetic disk, a CD-ROM, or a storage medium of any other form known in the art.

The preceding description of the disclosed embodiments enables those skilled in the art to implement or use the present disclosure. Various modifications to these embodiments will be readily apparent to those skilled in the art, and the generic principles defined herein may be implemented in other embodiments without departing from the spirit or scope of the present disclosure. Therefore, the present disclosure is not to be limited to the embodiments shown herein, but is to be accorded the widest scope consistent with the principles and novel features disclosed herein.

1. A short drama advertisement processing method, comprising:
sending an advertisement acquisition request to an advertisement platform;
receiving a short drama aggregated advertisement sent by the advertisement platform in response to the advertisement acquisition request, wherein the short drama aggregated advertisement is obtained by aggregating a plurality of short drama advertisements, and the plurality of short drama advertisements comprise at least a first short drama advertisement and a second short drama advertisement; and
displaying the short drama aggregated advertisement on a page, wherein the page comprises a first area and a second area, wherein the first area is used for playing the first short drama advertisement, and the second area is used for displaying information about the second short drama advertisement.

2. The method of claim 1, wherein the receiving the short drama aggregated advertisement sent by the advertisement platform comprises:
receiving a target link sent by the advertisement platform, wherein the target link is used for obtaining the short drama aggregated advertisement, wherein the target link is provided by an advertiser of the short drama aggregated advertisement to the advertisement platform, and wherein the short drama aggregated advertisement is obtained by the advertiser aggregating the plurality of short drama advertisements.

3. The method of claim 1, further comprising:
redirecting to a short drama platform corresponding to the first short drama advertisement in response to an operation triggered by a user on a first control in the first area, wherein the first control is used for triggering to view a short drama corresponding to the first short drama advertisement.

4. The method of claim 1, further comprising:
switching contents played in the first area to the second short drama advertisement, in response to a short drama advertisement viewing operation triggered by a user for information about the second short drama advertisement in the second area.

5. The method of claim 1, further comprising:
redirecting to a short drama platform corresponding to the second short drama advertisement in response to an operation triggered by a user on a second control in the second area, wherein the second control is used for triggering to view a short drama corresponding to the second short drama advertisement.

6. The method of claim 1, wherein the second area comprises a plurality of sub-areas, each of the sub-areas displays information about one short drama advertisement, and the second short drama advertisement is one of a plurality of short drama advertisements displayed in the second area.

7. An electronic device, comprising: a processor and a memory;
wherein the memory is configured to store an instruction or a computer program; and
wherein the processor is configured to execute the instruction or the computer program in the memory to cause the electronic device to perform:
sending an advertisement acquisition request to an advertisement platform;
receiving a short drama aggregated advertisement sent by the advertisement platform in response to the advertisement acquisition request, wherein the short drama aggregated advertisement is obtained by aggregating a plurality of short drama advertisements, and the plurality of short drama advertisements comprise at least a first short drama advertisement and a second short drama advertisement; and
displaying the short drama aggregated advertisement on a page, wherein the page comprises a first area and a second area, wherein the first area is used for playing the first short drama advertisement, and the second area is used for displaying information about the second short drama advertisement.

8. The electronic device of claim 7, wherein the receiving the short drama aggregated advertisement sent by the advertisement platform comprises:
receiving a target link sent by the advertisement platform, wherein the target link is used for obtaining the short drama aggregated advertisement, wherein the target link is provided by an advertiser of the short drama aggregated advertisement to the advertisement platform, and wherein the short drama aggregated advertisement is obtained by the advertiser aggregating the plurality of short drama advertisements.

9. The electronic device of claim 7, wherein the processor is configured to execute the instruction or the computer program in the memory to cause the electronic device to perform:
redirecting to a short drama platform corresponding to the first short drama advertisement in response to an operation triggered by a user on a first control in the first area, wherein the first control is used for triggering to view a short drama corresponding to the first short drama advertisement.

10. The electronic device of claim 7, wherein the processor is configured to execute the instruction or the computer program in the memory to cause the electronic device to perform:
switching contents played in the first area to the second short drama advertisement, in response to a short drama advertisement viewing operation triggered by a user for information about the second short drama advertisement in the second area.

11. The electronic device of claim 7, wherein the processor is configured to execute the instruction or the computer program in the memory to cause the electronic device to perform:
redirecting to a short drama platform corresponding to the second short drama advertisement in response to an operation triggered by a user on a second control in the second area, wherein the second control is used for triggering to view a short drama corresponding to the second short drama advertisement.

12. The electronic device of claim 7, wherein the second area comprises a plurality of sub-areas, each of the sub-areas displays information about one short drama advertisement, and the second short drama advertisement is one of a plurality of short drama advertisements displayed in the second area.

13. A non-transitory computer-readable medium having an instruction or a computer program stored thereon, wherein the instruction or the computer program, when executed on a device, causes the device to perform:
sending an advertisement acquisition request to an advertisement platform;
receiving a short drama aggregated advertisement sent by the advertisement platform in response to the advertisement acquisition request, wherein the short drama aggregated advertisement is obtained by aggregating a plurality of short drama advertisements, and the plurality of short drama advertisements comprise at least a first short drama advertisement and a second short drama advertisement; and
displaying the short drama aggregated advertisement on a page, wherein the page comprises a first area and a second area, wherein the first area is used for playing the first short drama advertisement, and the second area is used for displaying information about the second short drama advertisement.

14. The non-transitory computer-readable medium of claim 13, wherein the receiving the short drama aggregated advertisement sent by the advertisement platform comprises:
receiving a target link sent by the advertisement platform, wherein the target link is used for obtaining the short drama aggregated advertisement, wherein the target link is provided by an advertiser of the short drama aggregated advertisement to the advertisement platform, and wherein the short drama aggregated advertisement is obtained by the advertiser aggregating the plurality of short drama advertisements.

15. The non-transitory computer-readable medium of claim 13, wherein the instruction or the computer program, when executed on a device, causes the device to further perform:
redirecting to a short drama platform corresponding to the first short drama advertisement in response to an operation triggered by a user on a first control in the first area, wherein the first control is used for triggering to view a short drama corresponding to the first short drama advertisement.

16. The non-transitory computer-readable medium of claim 13, wherein the instruction or the computer program, when executed on a device, causes the device to perform:
switching contents played in the first area to the second short drama advertisement, in response to a short drama advertisement viewing operation triggered by a user for information about the second short drama advertisement in the second area.

17. The non-transitory computer-readable medium of claim 13, wherein the instruction or the computer program, when executed on a device, causes the device to perform:
redirecting to a short drama platform corresponding to the second short drama advertisement in response to an operation triggered by a user on a second control in the second area, wherein the second control is used for triggering to view a short drama corresponding to the second short drama advertisement.

18. The non-transitory computer-readable medium of claim 13, wherein the second area comprises a plurality of sub-areas, each of the sub-areas displays information about one short drama advertisement, and the second short drama advertisement is one of a plurality of short drama advertisements displayed in the second area.
